(19) United States
(12) Patent Application Publication
(10) Pub. No.: US 2003/0169860 A1
(43) Pub. Date: Sep. 11, 2003

(54) Multi-port multi-channel bi-directional communication device

(75) Inventor: Hsien-Chung Chou, Taipei (TW)

Correspondence Address: Finnegan, Henderson, Farabow,, Garrett & Dunner, L.L.P., 1300 I Street, N.W., Washington, DC, 20005-3315, US

(73) Assignee: Beauty Up Co., Ltd.

(21) Appl. No.: 10/167,447

(22) Filed: Jun. 13, 2002

(30) Foreign Application Priority Data
Mar. 5, 2002 (TW) 90103976

(51) Int. Cl. H04M 1/64; H04L 12/66

(52) U.S. Cl. 379/88.17; 370/352

(57) ABSTRACT

A multi-port multi-channel bi-directional communication device is proposed, which is designed for use with an information platform with audio I/O capability, such as a PC, a public information station, a mobile phone, a network video phone, a PDA, and the like, and which is provided with at least one network connecting port (such as RJ45 port) and at least one dial-up phone connecting port (such as RJ11 port), for the information platform to be selectively connected to either the Internet or the PSTN to provide either a VoIP (Voice over Internet Protocol) phone function or a dial-up phone function. The proposed communication device is characterized by that both the VoIP phone function and the dial-up phone function can be performed in a bi-directional way; and the VoIP phone function allows both static-to-dynamic and dynamic-to-dynamic IP address phone linking capability.

### BACKGROUND OF THE INVENTION

1. Field of the Invention

This invention relates to network-based telephony technology, and more particularly, to a multi-port multi-channel bi-directional communication device which is designed for use with an information platform with audio I/O capability, such as a PC (personal computer), a public information station, a mobile phone, a network video phone, a PDA (personal digital assistant), and the like, and which is provided with at least one network connecting port (such as RJ45 port) and at least one dial-up phone connecting port (such as RJ11 port), for the information platform to be selectively connected to either the Internet or the PSTN (Public Switched Telephone Network) to provide either a VoIP (Voice over Internet Protocol) phone function or a dial-up phone function.

2. Description of Related Art

Conventional dial-up telephony is based on the PSTN (Public Switched Telephone Network) system to link the caller's telephone unit to the receiver's telephone unit and use analog circuitry to transmit and process telephone signals. Nowadays, however, digital technology has been integrated to the PSTN system to allow the use of digital circuitry to transmit and process telephone signals.

With the advent of Internet, a new technology called VoIP (Voice over Internet Protocol) allows telephone users to be linked to each other via the Internet rather than via the conventional PSTN system. In VoIP, the caller needs just to use a data processing unit with audio I/O and Internet-linking functionality, such as a PC or an IP phone, to dial up over the Internet to the receivers telephone number.

Presently, Internet linking methods include ADSL (Asymmetric Digital Subscriber Line), cable modem, dial-up connection, and so on. Among these methods, the ADSL method utilizes one single telephone line for the transfer of both high-frequency IP signals and low-frequency dial-up telephone signals, and in which a gateway unit is used to split these two different kinds of signals apart and send them respectively to a PC unit and a dial-up telephone unit, whereby the PC unit can perform VoIP phone function while the dial-up telephone unit can perform dial-up phone function.

However, conventional technology can provide only uni-directional switching capability to VoIP telephony, and bi-directional switching capability is not allowed since conventional technology is unable to provide static-to-dynamic and dynamic-to-dynamic IP address phone linking function.

### SUMMARY OF THE INVENTION

It is therefore an objective of this invention to provide a multi-port multi-channel bi-directional communication device which is capable of providing a bi-directional VoIP phone and dial-up phone linking function.

It is another objective of this invention to provide a multi-port multi-channel bi-directional communication device which is capable of providing static-to-dynamic and dynamic-to-dynamic IP address phone linking function.

It is still another objective of this invention to provide a multi-port multi-channel bi-directional communication device which allows the user to selectively use it as a VoIP phone or a dial-up phone.

The multi-port multi-channel bi-directional communication device of the invention is designed for use with an information platform with audio I/O capability, such as a PC (personal computer), a public information station, a mobile phone, a network video phone, a PDA (personal digital assistant), and the like, and which is provided with at least one network connecting port (such as RJ45 port) and at least one dial-up phone connecting port (such as RJ11 port), for the information platform to be selectively connected to either the Internet or the PSTN Public Switched Telephone Network) to provide either a VoIP (Voice over Internet Protocol) phone function or a dial-up phone function.

The multi-port multi-channel bi-directional communication device of the invention is characterized by that both the VoIP phone function and the dial-up phone function can be performed in a bi-directional way; and the VoIP phone function allows both static-to-dynamic and dynamic-to-dynamic IP address phone linking capability.

### BRIEF DESCRIPTION OF DRAWINGS

The invention can be more fully understood by reading the following detailed description of the preferred embodiments, with reference made to the accompanying drawings, wherein:

FIG. 1 is a schematic diagram showing the application architecture of the multi-port multi-channel bi-directional communication device of the invention, and

FIG. 2 is a schematic diagram showing the inside architecture of the multi-port multi-channel bi-directional communication device of the invention.

### DETAILED DESCRIPTION OF PREFERRED EMBODIMENTS

The multi-port multi-channel bi-directional communication device according to the invention is disclosed in full details by way of preferred embodiments in the following with reference to the accompanying drawings.

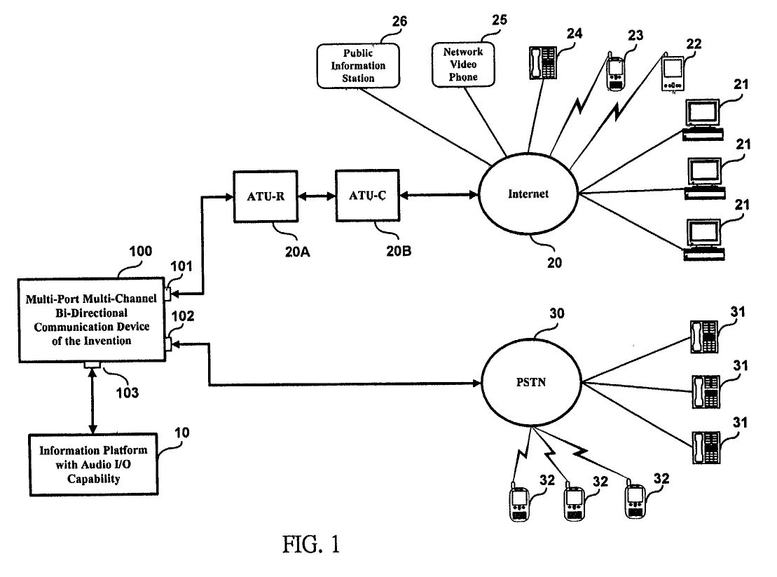

FIG. 1 is a schematic diagram showing the application architecture of the multi-port multi-channel bi-directional communication device of the invention 100. As shown, the communication device of the invention 100 is coupled to an information platform 10 with audio I/O capability, such as a PC (personal computer), a public information station, a mobile phone, a network video phone, a PDA (personal digital assistant), and the like, and which is provided with at least one network connecting port, such as an RJ45 port 101, and at least one dial-up phone connecting port, such as an RJ11 port 102, wherein the RJ45 port 101 is used for connection via an Internet-linking facility, such as an ATU-R unit 20A and an ATU-C unit 20B, to the Internet 20; while the RJ11 port 102 is used for connection to the PSTN system 30, for the purpose of allowing the information platform 10 to be selectively linked to either the Internet 20 or the PSTN system 30 to provide either a VoIP (Voice over Internet Protocol) phone function or a dial-up phone function.

When the user chooses to use the VoIP phone function, the communication device of the invention 100 is activated to connect the information platform 10 to the Internet 20, and then via the Internet 20 to any IP-based telephone unit around the world, such as a PC 21, a PDA 22, a mobile phone 23, an IP phone 24, a network video phone 25, a public information station 26, and so on.

On the other hand, when the user choose to use the dial-up phone function, the communication device of the invention 100 is activated to connect the information platform 10 to the PSTN system 30 for connection to a conventional dial-up telephone unit around the world, such as a desktop telephone unit 31 or a mobile phone 32 of the GSM (Global System for Mobile Communications) or the GPRS (Global Packet Radio Service) type.

In addition to outgoing call , the communication device of the invention 100 is capable of receiving an incoming call, either via the Internet 20 or via the PSTN system 30, from any telephone unit around the world. In other words, the communication device of the invention 100 is capable of providing a bi-directional phone linking function for the user.

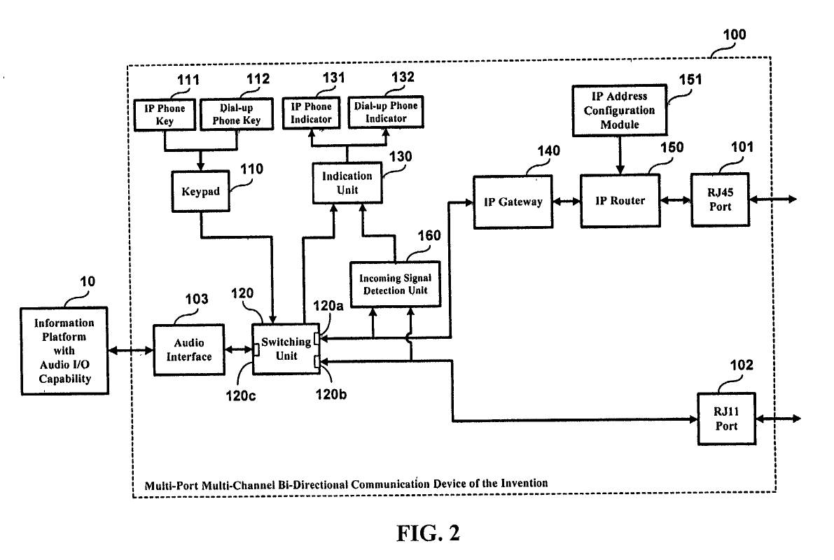

FIG. 2 is a schematic diagram showing the inside architecture of the communication device of the invention 100. As shown, the communication device of the invention 100 comprises: (a) at least one network connecting port, such as an RJ45 port 101; (b) at least one dial-up phone connecting port, such as an RJ11 port 102; (c) an audio interface 103; (d) a keypad 110; (e) a switching unit 120; (f) an indication unit 130; (g) an IP gateway 140; (h) an IP router 150; and (i) an incoming signal detection unit 160.

The network connecting port 101 can be, for example, an RJ45 port or an equivalent, which is used to externally connect the communication device of the invention 100 to an Internet linking facility, such as an ATU-R unit 20A and an ATU-C unit 20B, for the purpose of connecting the communication device of the invention 100 to the Internet 20.

The dial-up phone connecting port 102 can be, for example, an RJ11 port or an equivalent, which is used to externally connect the communication device of the invention 100 to the PSTN system 30.

The audio interface 103 is used to externally couple the communication device of the invention 100 to the information platform 10, which can be either a PC, or a public information station, or a mobile phone, or a network video phone, a PDA, or the like, for receiving the output audio signal from the information platform 10 or transferring an incoming call to the information platform 10. Furthermore, the audio interface 103 is used to convert the audio signal format of the incoming call into one that can be accepted by the operation system, such as Windows or Unix, running on the information platform 10.

The keypad 110 includes a VoIP phone key 111 and a dial-up phone key 112; wherein the VoIP phone key 111 allows the user to manually switch the communication device of the invention 100 to operate in VoIP phone mode, whereas the dial-up phone key 112 allows the user to manually switch the communication device of the invention 100 to operate in dial-up phone mode.

The switching unit 120 includes a first I/O port 120a, a second I/O port 120b, and a third I/O port 120c; wherein the first I/O port 120ais connected to the IP gateway 140, the second I/O port 120b is connected to the RJ11 port 102, and the third I/O port 120c is connected to the audio interface 103. The switching unit 120 is controlled by the keypad 110 to operate in such a manner that when the VoIP phone key 111 is pressed down by the user, it causes the third I/O port 120c 6to be connected to the first I/O port 120a, and whereas when the dial-up phone key 112 is pressed down, it causes the third I/O port 120c to be connected to the second I/O port 120b.

The indication unit 130 includes a VoIP phone indicator 131 and a dial-up phone indicator 132; wherein the VoIP phone indicator 131 will be lighted up when the communication device of the invention 100 operates in the VoIP phone mode, and the dial-up phone indicator 132 will be lighted up when the communication device of the invention 100 operates in the dial-up phone mode.

During operation, the user can use the keypad 110 to switch between the VoIP phone mode of operation and the dial-up phone mode of operation; i.e., when the VoIP phone key 111 is pressed down, it switches the communication device of the invention 100 to operate in the VoIP phone mode; and whereas when the dial-up phone key 112 is pressed down, it switches the communication device of the invention 100 to operate in the dial-up phone mode.

In VoIP phone mode of operation, the keypad 110 activates the indication unit 130 to light up the VoIP phone indicator 131, and meanwhile activates the switching unit 120 to connect the third I/O port 120c to the first I/O port 120a, thereby connecting the audio interface 103 to the IP gateway 140. This allows the output audio signals from the information platform 10 to be transferred successively via the audio interface 103, the switching unit 120, the IP gateway 140, and the IP router 150 to the RJ45 port 101 for further transfer over the Internet 20 to the receiver (the PC 21, the PDA 22, the mobile phone 23, the IP phone 24, the network video phone 25, or the public information station 26). Moreover, during this mode of operation, the user can use the IP-address configuration module 151 to configure the IP address for the receiver of each outgoing call, so that the output audio signals from the information platform 10 can be transferred by the IP router 150 to the specified receiver. This allows static-to-dynamic and dynamic-to-dynamic IP address phone linking function.

On the other hand, in the dial-up phone mode of operation, the indication unit 130 is activated to light up the dial-up phone indicator 132, and meanwhile the switching unit 120 is activated to connect the third I/O port 120c to the second I/O port 120b, thereby connecting the audio interface 103 to the RJ11 port 102. This allows the output audio signals from the information platform 10 to be transferred successively via the audio interface 103 and the switching unit 120 to the RJ11 port 102 for further transfer over the PSTN system 30 to the receiver (the desktop telephone unit 31 or the mobile phone 32).

Beside the capability of issuing outgoing calls, the communication device of the invention 100 is also capable of receiving incoming calls, including both VoIP phone calls and dial-up phone calls; i.e., the communication device of the invention 100 is capable of receiving an incoming call via the Internet 20 from either the PC 21, the PDA 22, the mobile phone 23, the IP phone 24, the network video phone 25, or the public information station 26, as well as via the PSTN system 30 from either the desktop telephone unit 31 or the mobile phone 32 shown in FIG. 1.

Whenever the communication device of the invention 100 receives an incoming call, it is first detected by the incoming signal detection unit 160 to check whether the incoming call is a VoIP phone call or a dial-up phone call.

If the incoming call is a VoIP phone call, the incoming signal detection unit 160 will activate the indication unit 130 to light up the VoIP phone indicator 131 to inform the user of this condition. In response, the user can promptly press down the VoIP phone key 111 to activate the switching unit 120 to connect the third I/O port 120c to the first I/O port 120a, thereby connecting the audio interface 103 to the IP gateway 140, so that the incoming signal can be transferred to the information platform 10.

On the other hand, if the incoming call is a dial-up phone call, the incoming signal detection unit 160 will activate the indication unit 130 to light up the dial-up phone indicator 132 to inform the user of this condition. In response, the user can promptly press down the dial-up phone key 112 to activate the switching unit 120 to connect the third I/O port 120c to the second I/O port 120b, thereby connecting the audio interface 103 to the RJ11 port 102, so that the incoming signal can be transferred to the information platform 10.

In one embodiment of the invention, the VoIP phone indicator 131 and the dial-up phone indicator 132 are arranged respectively to the next of the VoIP phone key 111 and the dial-up phone key 112, so that when one of them is lit up, the user can promptly press down the corresponding one of the VoIP phone key 111 and the dial-up phone key 112.

In another embodiment, the incoming signal detection unit 160 and the switching unit 120 can be designed in such a manner that the incoming signal detection unit 160 will automatically activate the switching unit 120 to switch based on the type of the incoming call; i.e., when the incoming call is an IP phone call, the incoming signal detection unit 160 will automatically activate the switching unit 120 to connect the third I/O port 120c to the first I/O port 120a; and whereas when the incoming call is a dial-up phone call, the incoming signal detection unit 160 will automatically activate the switching unit 120 to connect the third I/O port 120c to the second I/O port 120b.

In conclusion, the invention provides a multi-port multi-channel bi-directional communication device, which is designed for use with an information platform with audio I/O capability, such as a PC, a public information station, a mobile phone, a network video phone, a PDA, and the like, and which is capable of performing either a VoIP phone function or a dial-up phone function. The communication device of the invention is characterized by that both the VoIP phone function and the dial-up phone function can be performed in a bi-directional way; and the VoIP phone function allows both static-to-dynamic and dynamic-to-dynamic IP address phone linking capability. The invention is therefore more advantageous to use than the prior art.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A multi-port multi-channel bi-directional communication device for use with an information platform having audio I/O capability for selectively connecting the information platform to either the Internet or the PSTN system to perform either a VoIP phone function or a dial-up phone function;
the multi-port multi-channel bi-directional communication device comprising:
(a) a network connecting port for connection to the Internet;
(b) a dial-up phone connecting port for connection to the PSTN system;
(c) an audio interface for connection to the information platform;
(d) a keypad including a VoIP phone key and a dial-up phone key;
(e) a switching unit including a first I/O port, a second I/O port, and a third I/O port;
wherein the first I/O port is connected to the network connecting port, the second I/O port is connected to the dial-up phone connecting port, and the third I/O port is connected to the audio interface;
(f) an indication unit, which is used to indicate whether the multi-port multi-channel bi-directional communication device is currently operating in VoIP phone mode or in dial-up phone mode;
(g) an IP gateway, which can be switchably connected by the switching unit to the audio interface, for providing an IP gateway function to the output signals from the audio interface;
(h) an IP router, which is connected to the IP gateway, for providing an IP routing function to the output signals from the IP gateway; and which includes an IP-address configuration module for assigning IP addresses to the IP router for providing static-to-dynamic and dynamic-to-dynamic IP address phone linking capability; and
(i) an incoming signal detection unit, which is connected to receive the incoming calls from the network connecting port and the incoming calls from the dial-up phone connecting port, for detecting whether each incoming call is an IP phone call or a dial-up phone call; if IP phone call, the incoming signal detection unit activates the indication unit to light up the VoIP phone indicator; whereas if a dial-up phone call, the incoming signal detection unit activates the indication unit to light up the dial-up phone indicator.

2. The multi-port multi-channel bi-directional communication device of claim 1, wherein the network connecting port is an RJ45 port.

3. The multi-port multi-channel bi-directional communication device of claim 1, wherein the dial-up phone connecting port is an RJ11 port.

4. The multi-port multi-channel bi-directional communication device of claim 1, wherein the information platform is one of the types comprising a PC, a public information station, a mobile phone, a network video phone, and a PDA.
